(19) United States
(12) Patent Application Publication
(10) Pub. No.: US 2025/0378680 A1
(43) Pub. Date: Dec. 11, 2025

(54) METHOD OF GENERATING HIGHLY CONSISTENT PREDICTED VALUES FROM PLANER IMAGES

(71) Applicant: Alpha Intelligence Manifolds, Inc., New Taipei City (TW)

(72) Inventors: CHENG WEI LIN, New Taipei City (TW); SHENG CHE HSIAO, New Taipei City (TW); QINGZONG TSENG, New Taipei City (TW)

(21) Appl. No.: 18/735,197

(22) Filed: Jun. 6, 2024

(51) Int. Cl. G06V 10/774; G06T 7/00; G06V 10/25; G06V 10/776

(52) U.S. Cl. CPC G06V 10/7753; G06T 7/0012; G06V 10/25; G06V 10/776; G06T 2207/10116; G06T 2207/20081; G06T 2207/20084; G06T 2207/30008; G06V 2201/033

(57) ABSTRACT

The present invention relates to a method of training a prediction model to generate a main predicted value of a main feature of an input image. The method comprises training the prediction model with a primary dataset containing labeled training images labeled with ground truth values and a secondary dataset containing two unlabeled training images without ground truth values. The training goal is to reduce both a first loss and a second loss, wherein the first loss calculates the difference between predicted values of the labeled training image and the ground truth values, and the second loss calculates the difference between predicted values of the two unlabeled training images.

### BACKGROUND OF THE INVENTION

### Field of the Invention

The present invention relates to a method for generating predicted values from a planar image with high consistency, especially for generating the skeletal characteristic values related to osteoporosis and fracture risk of a subject from a radiographic image.

### Description of Related Art

According to the definition of the World Health Organization (WHO), osteoporosis is a systemic bone disease characterized by decreased bone mass and deterioration of the microstructure of bone tissue, resulting in fragile bones and an increased risk of fracture. Patients may also have multiple complications following fractures. Since osteoporosis is usually painless and has no obvious symptoms, one must take examinations to know whether he/she has osteoporosis or not.

The diagnosis of osteoporosis can be made by measuring the bone mineral density (BMD). Besides standard method such as dual-energy X-ray absorptiometry (DXA), other AI-related methods to generate BMD values are also available.

Because BMD values can be used as indicators for treatment effectiveness or tracking indicators, or can be used as a basis for continuous monitoring of patient bone quality, it is often performed in a continuous manner, which requires a certain degree of consistency. According to the guidelines issued by the International Society for Clinical Densitometry (ISCD), when the same operator performs continuous repeated measurements (usually 30 people, each for two consecutive measurements), the DXA precision measured by coefficient of variation (CV) should be within 1.8%-2.5%.

Currently, the use of AI to predict bone density values is mainly used in screening to identify osteoporosis of a subject, instead of used to continuously monitor bone density values. The main reason is that the bone density estimates made by an AI model on different X-ray images of the same person taken within a short period of time (usually 3-6 months) may be very different (e.g., way larger than the 1.8-2.5% as specified by ISCD). Those differences originating from the training methods of different AI models, however, are difficult to control due to the hard-to-interpret nature of AI models. This causes difficulties in applications of an AI model to estimate bone density in serial measurements.

Therefore, a new method to improve the consistency of AI output, especially the skeletal characteristic values related to osteoporosis and fracture risk of a subject, is still desired.

### SUMMARY OF THE INVENTION

To resolve the problems, the present invention provides a method to generating values of a main feature from planar images with high consistency. The method introduces a second loss term in addition to a conventional first loss term in model training. This method thus provides an enhanced stability to the predicted result of the model.

Specifically, the present invention provides a method of training a prediction model to generate one or more main predicted values of a main feature of an input image, comprising training the prediction model with a primary dataset and a secondary dataset by adjusting multiple parameters in the prediction model to lower a total loss of the prediction model. In this method, the primary dataset comprises multiple primary learning data, each of which comprises a labeled training image labeled with one or more main ground truth values of the main feature; whereas the secondary dataset comprises multiple secondary learning data, each of which comprises an unlabeled training image pair containing a first unlabeled training image and a second unlabeled training image having similarity in the main feature. The total loss used to adjust the multiple parameters comprises a primary loss and a secondary loss. During training, the prediction model may generate one or more primary predicted values of the main feature of the labeled training image, and the primary loss is calculated based on the difference between the one or more main ground truth values and the one or more primary predicted values. Likewise, the prediction model may generate one or more first predicted values of the main feature of the first unlabeled training image, and generate one or more second predicted values if the main feature of the second unlabeled training image. The secondary loss is calculated based on the difference between the one or more first predicted values and the one or more second predicted values. In one embodiment, the primary loss is calculated by a primary loss function, and the secondary loss is calculated by a secondary loss function. And in a specific embodiment, the primary loss function and the secondary loss function calculate squared loss.

In one embodiment, to ensure a similarity in the main, in each of the multiple secondary learning data the first unlabeled training image and the second unlabeled training image are images of the same subject taken within a predetermined time interval, wherein within the predetermined time interval the main feature is known to be constant or only varies within the measurement limit of the measuring method. Specifically, the predetermined time interval may be 3 months or 6 months.

Instead of using an original training image, in one embodiment each of the labeled training image, the first unlabeled training image and the second unlabeled training image is an ROI (region of interest) extracted image extracted from an original training image via ROI extraction. The ROI is the region closely related to the main feature. Said ROI extraction may be performed by a trained ROI extraction model. Alternatively, each of the labeled training image, the first unlabeled training image and the second unlabeled training image may also be a training image set comprising an original training image and an ROI extracted image, and the prediction model may use both images in the image set to predict main feature values.

Besides the main feature, in one embodiment one or more auxiliary features are used, and the method further comprises training the prediction model to generate one or more auxiliary predicted values of the one or more auxiliary features of the input image by adjusting the multiple parameters in the prediction model to lower the total loss of the prediction model. To use the auxiliary features for model training, it requires that the one or more auxiliary features are correlated with the main feature. In this embodiment, the labeled training image of each of the multiple primary learning data is further labeled with one or more auxiliary ground truth values of the one or more auxiliary features. The total loss used to adjust the multiple parameters further comprises a tertiary loss. During training, the prediction model may further generate one or more tertiary predicted values of the one or more auxiliary features of the labeled training image, and the tertiary loss is calculated based on the difference between the one or more auxiliary ground truth values and the one or more tertiary predicted values.

During training, data augmentation may also be applied to the prediction model. In one embodiment, the labeled training image is modified by image augmentation before generating the one or more primary predicted values by the prediction model. In one embodiment, the one or more main ground truth values are modified by ground truth augmentation before calculating the primary loss.

In a preferred embodiment, the main feature is bone density of a subject, and the one or more main predicted value are one or more bone mineral density (BMD) values. In one specific embodiment, the one or more main predicted values comprise bone mineral density (BMD) values of total hip, femoral neck, greater trochanter, and femoral shaft.

In a specific embodiment, the prediction model is trained to generate BMD values from X-ray images. In this embodiment, the labeled training image in each of the primary learning data, and the first unlabeled training image and the second unlabeled training image in each of the secondary learning data are X-ray images.

In one embodiment, the first unlabeled training image and the second unlabeled training image are two X-ray images of the same subject taken sequentially within 3 months.

The model for BMD prediction may use one or more auxiliary features to improve the model's ability to generate BMD values. In this case, the method may further comprise training the prediction model to generate one or more auxiliary predicted values of the one or more auxiliary features of the input image by adjusting the multiple parameters in the prediction model to lower the total loss of the prediction model. To use the auxiliary features for model training, it requires that the one or more auxiliary features are correlated with bone density of a subject. The one or more auxiliary features may comprise cortical thickness of the subject, and the auxiliary predicted value corresponding to cortical thickness is a cortical thickness index (CTI) value of the subject. The one or more auxiliary features may also comprise femoral neck width of the subject, and the auxiliary predicted value corresponding to femoral neck width is a femoral neck width (FNW) value of the subject.

Usually, the X-ray images taken in health facilities are images of whole pelvic region. To enable the prediction model to focus on regions which are closely related to the main feature, ROI (region of interest) extracted images instead of the whole X-ray images may be used as the training images. In this embodiment, the labeled training image is an ROI (region of interest) extracted image which is an identified ROI region of a hip joint extracted from an original training image. Alternatively, to retain more information of the original training image, the labeled training image may be a training image set comprising the original training image and the ROI extracted image.

In one specific embodiment, the original training image and the ROI extracted image are modified by image augmentation before generating the one or more primary predicted values by the prediction model. Said image augmentation may be performed by cropping 0-25% of the original training image without cropping the identified ROI region, and said image augmentation may be performed by shifting the identified ROI region by 0-7% in a specific direction.

In one specific embodiment, the one or more main ground truth values are modified by ground truth augmentation before calculating the primary loss. Said ground truth augmentation may be performed by introducing small variables to the one or more main ground truth values. The values of small variables may be independent to the main ground truth values. In one embodiment, each of the small variables is a value randomly selected between −0.01 g/cm² and 0.01 g/cm². In one specific embodiment, each of the small variables is randomly selected from a normal distribution with population mean of 0 which truncates at ±0.01 g/cm², and the normal distribution may have a standard deviation of 0.01 g/cm². Alternatively, the values of small variables may also depend on the main ground truth values. In one embodiment, each of the one or more main ground truth having a value yₙ, each of the small variable is a value randomly selected between −0.01yₙ and 0.01yₙ.

Other objectives, advantages and novel features of the invention will become more apparent from the following detailed description when taken in conjunction with the accompanying drawings.

### BRIEF DESCRIPTION OF THE DRAWINGS

FIG. 1 shows the architecture of a prediction model training with a labeled dataset and an unlabeled dataset.

FIG. 2 shows the architecture of a prediction model training with a labeled dataset labeled with both the main feature and the auxiliary feature.

FIG. 3 shows the architecture of a prediction model training with augmented data.

FIG. 4 shows a prediction model concatenating with an ROI extraction model. The prediction model takes the extracted ROI as its input to generate a predicted value.

FIG. 5A shows a training image of total hip with left and right hip joint labeled by a radiologist. FIG. 5B shows a training image of hip joint region with femoral neck, greater trochanter and femoral shaft labeled by a radiologist. FIG. 5C is the results of ROI identification for BMD generation, which identifies hip joint regions as regions of interest.

FIG. 6 shows an example to feed the data into the model, wherein a set of primary learning data randomly selected from the primary dataset and a set of secondary learning data randomly selected from the secondary dataset are combined and used to calculate a total loss.

FIG. 7 shows an example to calculate a total loss, which comprises an accuracy term and a precision term.

FIG. 8 shows the characteristic points corresponding to the outer and inner edges of the cortical bone used in calculating CTI values in CTI calculation model.

FIG. 9 shows an example of performing random displacement to ROI. In this example, the ROI region is enlarged from the center for all 4 sides before image cropping.

FIG. 10 shows an example of data augmentation. The augmented data from primary dataset comprises augmented image (P₁′) and augmented ground truth values (Bₕ₁′, B_{fn1}′, B_{gt1}′, and B_{fs1}′).

### DETAILED DESCRIPTION OF PREFERRED EMBODIMENTS

The terminology used in the description presented below is intended to be interpreted in its broadest reasonable manner, even though it is used in conjunction with a detailed description of certain specific embodiments of the technology. Certain terms may even be emphasized below; however, any terminology intended to be interpreted in any restricted manner will be specifically defined as such in this Detailed Description section.

The embodiments introduced below can be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), graphics processing units (GPUs), etc.

The aim of the present invention is to provide a method to train an AI model to generate main predicted values with high precision for a main feature of input images. In other words, the trained model should be able to generate consistent results for input images with similar values for the main feature, regardless of the noise in the images. This improvement can be achieved by introducing an extra “precision term” in the loss function during model training, which will be described in detail below.

An AI model may learn to generate output values from input images with the training of a labeled training dataset. This model may be established by using convolutional neural network (CNN) based algorithm such as LeNet, AlexNet, VGG, GoogLeNet, ResNet, and DenseNet. Transformer-based vision algorithms (such as ViT) may also be used. Each set of the learning data in the labeled training dataset comprises a training image labeled with its ground truth value(s) as the learning goal for the model to learn. An AI model trained with this approach, however, might generate outputs with high variations for similar inputs (e.g., two or more inputs deemed to have nearly identical ground truth values). Because of the hard-to-interpret nature of AI models, this kind of variations are hard to control. One possibility to deal with this problem is to increase the size of the labeled training dataset by including more learning data. Nevertheless, a large quantity of labeled learning data is not always available, which often prevents one from training the model with this approach.

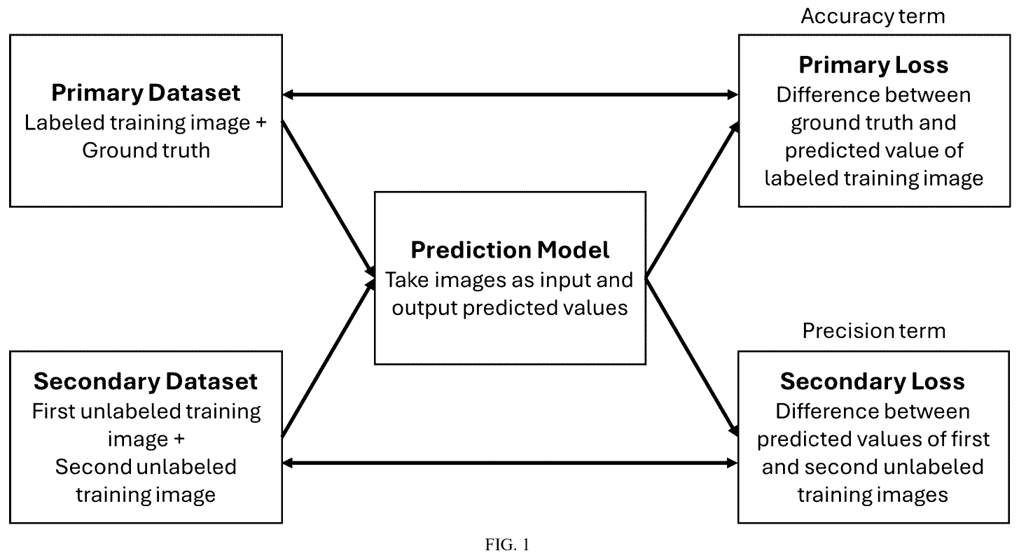

Although labeled learning data are hard to be obtained in large quantity, image sets containing unlabeled images with a certain degree of shared property or similarity in the main feature are much easier to obtain because no labeling work is required. Thus, the model may be trained with an additional unlabeled training dataset. Each set of the learning data in the unlabeled training dataset is an image set comprising two or more training images which are deemed to have essentially the same value of the main feature. The learning goal for the model to learn from the unlabeled training dataset is to generate outputs with small variations among training images in every image set. By applying this extra goal, the model may learn to generate consistent outputs for input images with similarity in main feature, as shown in FIG. 1.

The main feature values of two or more images may be considered as “the same” or “indistinguishable” if the inferred intrinsic differences among those values are much less than the precision error to obtain those values. Two or more images taken within a short period of time, for example, is a frequently used method to obtain image pair/image set with similar main feature. In preferred embodiments, the main feature is a measurable biological feature of a human. This may include but not limited to height, weight, serum albumin, and bone density. The values of those features may change over time, but for each feature value a “short period of time” can be found so that within this short period of time the natural change of feature value will always be smaller than the detection limit or the measurement error of corresponding measuring method. Because the true difference of two feature values measured within the short period of time is surpassed by the measurement error, the true difference cannot be analyzed by this measuring method and should be considered “indistinguishable” or “similar”. The length of the short period of time is predetermined based on the knowledge on (1) the maximal change rate of the measured feature, and (2) the measurement error or the detection limit of the measuring method to acquire feature values, so that the product of the maximal change rate times the predetermined short period of time is smaller than the measurement error or the detection limit of the measuring method. In other words, any two feature values measured from the same person within the predetermined short period of time are similar to each other.

Specifically, in bone mineral density (BMD) test measured by dual-energy X-ray absorptiometry (DXA), the variation of repeated measurements by the same operator is around 2%. However, research shows that BMD changes for a person is normally under 1% per year. Therefore, two X-ray images of the same person taken within 3 or 6 months can be reasonably considered as “similar”, as the intrinsic BMD change of the same person within 6 months is much less than 2%, which is not a measurable difference by DXA considering its precision error on repeated measurements. Other examples include measuring body weight of the same person within one or two days, or measuring serum albumin concentration of the same person within several hours, where in both cases the precision error may be larger than the intrinsic difference itself.

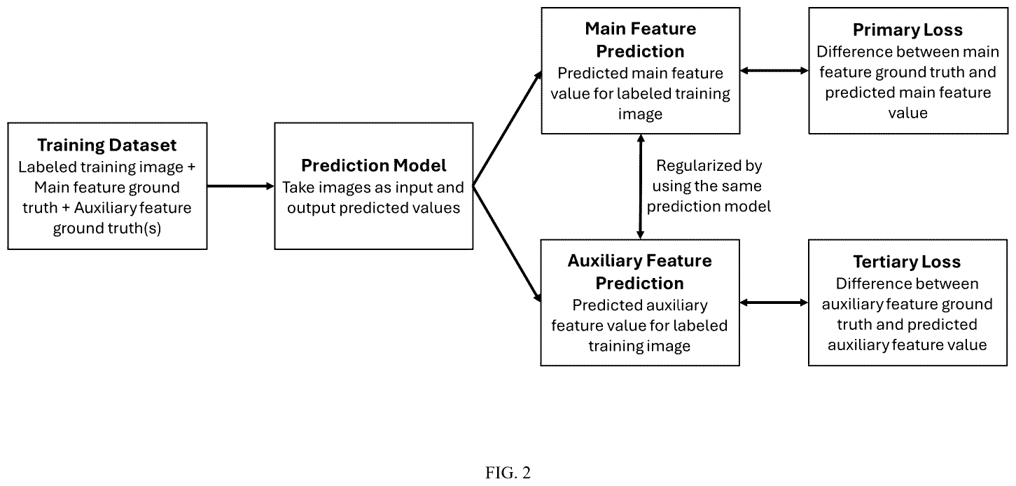

Besides training the model to generate only one output from the input, a model may also be trained to generate multiple outputs from the input image. If the training image is labeled with multiple ground truth values, the model may learn to generate those values as the multiple outputs at the same time. For example, the model may be trained to generate only a value of a main feature as the output, or it may be trained to generate multiple values including one or more values of the main feature and several values of auxiliary features. We may select one or more auxiliary features which are correlated with the main feature, and train the model to generate values of the auxiliary features, as shown in FIG. 2.

Training the model to generate outputs other than the main feature value may serve as an extra guidance to adjust the parameters for outputting the main feature value, because the main feature and the selected auxiliary features are interrelated. Also, generating several values of the main feature (instead of only one main feature value) may also improve the performance of the model, because the model may learn more feature details from generating multiple values. For example, research shows that the cortical thickness index (CTI) and femoral neck width (FNW) values of a hip joint are correlated with the bone mineral density (BMD) value of the hip joint region. Therefore, training a model to predict CTI and FNW values besides BMD may improve the model's performance in predicting BMD values, since the three values of a hip joint share some common factors, which may be learned by the model during training.

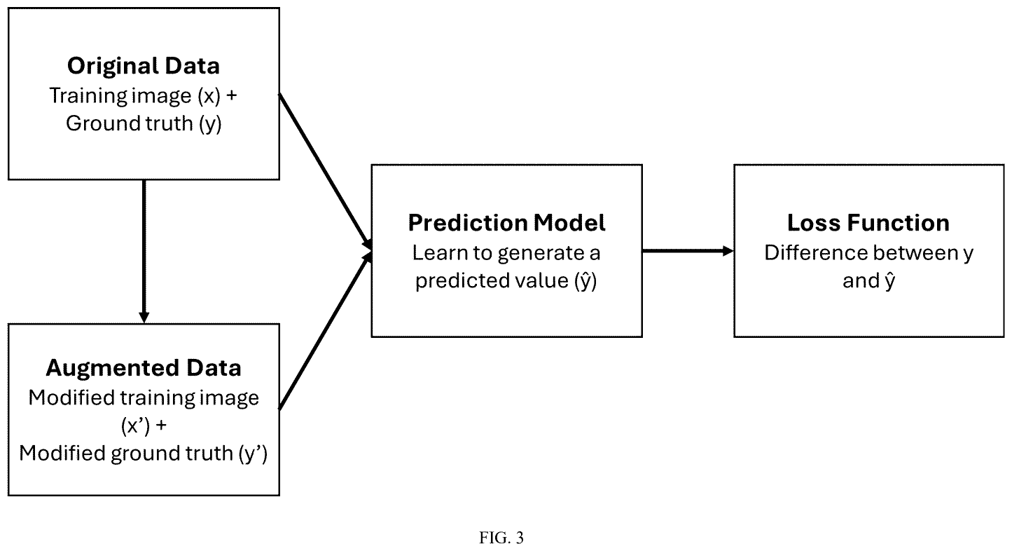

Various kinds of data augmentation techniques may also be applied to increase the variability of training data for a better model generalization and performance. Data augmentation may include input image augmentation and/or ground truth augmentation, as shown in FIG. 3. Because data augmentation creates artificial data other than real inputs/measurements, it requires domain knowledge to create reasonable augmented data. A “reasonable” augmented data means the data may actually obtained during data acquisition. For example, a reasonable augmented input image may correspond to the variations during image acquisition, and a reasonable augmented ground truth may correspond to the variations of the measured values caused by instrumental or operational noises.

In image augmentation, an original input image may be modified with geometric transformations, color space transformations, and noise injection. Geometric transformations include rotation (which rotates images by a specified degree), flipping (which reflects images horizontally or vertically), cropping (which removes part of the original image), and shifting (which shifts images in different directions). Color space transformations may modify the color properties of images such as lighting, color saturation, and contrast. In addition, noises may be introduced into images to simulates real-world imperfections. The adjusted image represents a slightly modified copy of the original input image which should have a ground truth value the same as that of the original input image. For radiographic images, those adjustments mimic the variations during image acquisition, such as posture, positioning or offset of the patient, X-ray energy of the instrument, and differences caused by operators. The data augmentation parameters applied during training are based on the principle of complying with the variations that may occur when taking conventional X-ray images. Examples include scaling/translation within 5% of the image size, rotation below 15 degrees, Gamma correction within 25% to mimic overexposure/underexposure, introducing random Gaussian blur to mimic focus deviation, and introducing random Gaussian noise to mimic sensor noise.

In ground truth augmentation, the ground truth value of an input image is slightly modified within a reasonable range to mimic the variation during repeated measurements to the same subject. In general, any variation smaller than the measurement accuracy can potentially be used in ground truth augmentation to mimic the variation caused by repeated measurements. For example, in BMD measurement by DXA, a reasonable coefficient of variation (CV) for repeated measurement to the same patient is around 2%. Therefore, adjusting a specific BMD value within 1% range may be considered an acceptable modification to create an artificial data point corresponding to the original data for model training.

In summary, with one original image and the corresponding ground truth value, many modified images and many modified output values may be generated, and the combination of the many modified images and the many modified output values may effectively expand the training dataset for model training.

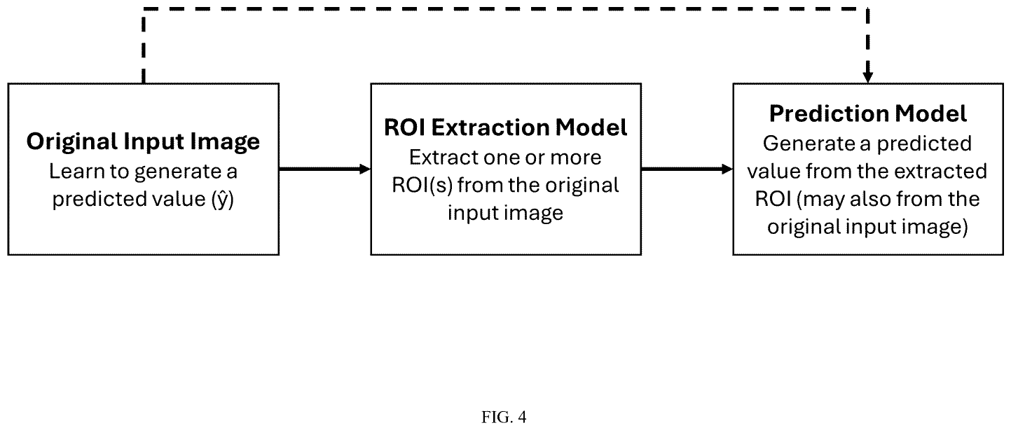

The framework of the AI model may be designed based on the properties of input images. It may be a single model which predict one or more output values from an input image. Alternatively, it may also be an integrated model which catenating two or more sub-models, wherein each sub-model handles a specific task. For example, a prediction model may concatenate with a region of interest (ROI) location/extraction model so that the ROI location model may extract key region(s) of the input image to the prediction model, as shown in FIG. 4. This enables the prediction model to focus on regions which are closely related to the main feature. The prediction model may receive the extracted ROI as its input, or it may receive both the original image and the extracted ROI as its input. In the latter case, the prediction model uses an image set comprising both the original image and the extracted ROI as its input.

Specifically, an integrated AI model for predicting the bone mineral density (BMD) value(s) of a subject from a planar X-ray image may be implemented by concatenating an ROI location model with a BMD generation model. To train an integrated AI model with such framework, an ROI location model is independently established first, then the established ROI location model may process an original training X-ray image and output the ROIs related to BMD of the original training image (e.g., total hip, femoral neck, greater trochanter, and femoral shaft). The identified ROIs are then used as training inputs for the BMD generation model to adjust its parameters in the BMD generation model. When training the BMD generation model, the parameters of the ROI location model are not altered. Performing ROI location first before BMD generation may have advantageous effect compared to a single model which predicts the BMD value directly from the input X-ray image, because the identified regions of interest (ROIs) may force the BMD generation model to focus on the key features related to BMD value(s).

The following shows examples of establishing an integrated model for BMD generation based on the concepts described above. The efficacies of the established model are also provided. In some examples, the integrated model comprises an ROI location model and a BMD generation model. In the ROI location model, an X-ray image with at least one hip joint is used as the original input image for the model to extract the hip joint region. The extracted ROIs may be used as inputs for the BMD generation model to generate predicted BMD values.

### 1. ROI Location Model

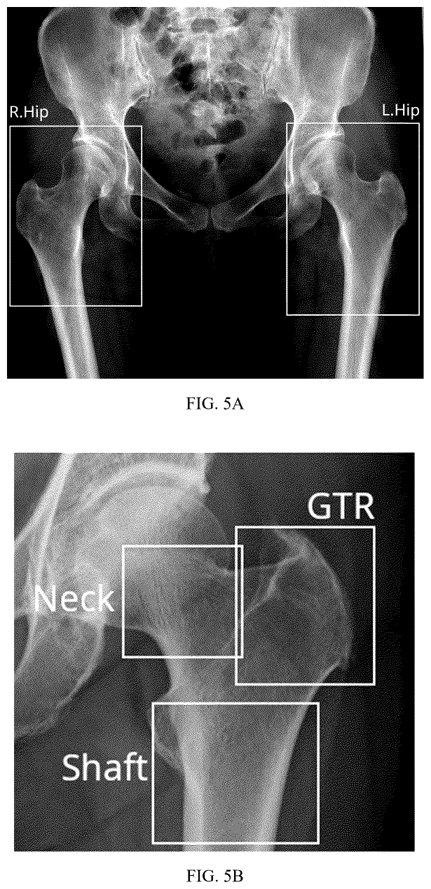

An object detection AI model, as described in US Patent Publication No. US2023/0029674A1, the contents of which are incorporated herein by reference, is trained to identify regions of interest (ROIs) in an input X-ray image. A deep neural network (DNN) model, You Only Look Once (YOLO) algorithm, is implemented to train the AI to identify the features and select suitable ROIs from the input image. The training dataset and training workflow for ROI location model are as described below:
(1) For training data preparation, the ROIs in the X-ray images are labeled by experts as the training ground truth for the object detection model. Clinical data of 459 pelvic X-ray images from health facilities are transformed from DICOM files into high-resolution 16-bit PNG files. The images with abnormal bones such as artificial joints or fractures are excluded. The brightness and contrast of the images are then adjusted to a standard range. Lastly, regions of hip joint, femoral neck, greater trochanter and femoral shaft are labeled by radiologists as the training ground truth, as shown in FIGS. 5A and 5B.
(2) The labeled ROIs (the bounding boxes in FIGS. 5A and 5B) and the unlabeled corresponding X-ray images are used to train the object detection model implementing YOLO algorithm.
(3) After training, the model is able to locate ROIs in the incoming pelvic X-ray images. The ROI of hip joint region is located from the original X-ray image, and the ROIs of femoral neck, greater trochanter and femoral shaft are located from the ROI of hip joint region.

FIG. 5C is the results of ROI identification for BMD generation, which selects hip joint regions as regions of interest. The trained ROI location model can also recognize the regions femoral neck, greater trochanter and femoral shaft. However, in the present invention the hip joint region is the only ROI required in BMD generation. The hip joint region is identified from an original input image, and the hip joint ROI is used as an input in the BMD generation model described below.

### 2. BMD Generation Model

An AI model for BMD generation from an input X-ray image is described in US Patent Publication No. US2023/0029674A1, the contents of which are incorporated herein by reference. In the present invention, an AI model is trained to generate the values of not only bone mineral density (BMD), but also the cortical thickness index (CTI) and the femoral neck width (FNW). BMD is the amount of bone mineral in bone tissue; CTI is defined as the ratio of cortical width minus endosteal width to cortical width at a level of 100 mm below the tip of the lesser trochanter; and FNW is defined as the mid-point distance between the superior cortex and the inferior cortex of the femoral neck perpendicular to the femoral neck axis. Research has shown that the BMD, CTI and FNW are intercorrelated, and so the BMD generation model is trained to predict values of all the above features simultaneously for a better accuracy. Here BMD is the main feature for the AI model to learn, whereas CTI and FNW are auxiliary features. The BMD generating model may be trained to generate only one BMD values, or it may be trained to generate multiple BMD values corresponding to different regions. For example, the model may be trained to generate only a BMD value of total hip joint, or it may be trained to generate 4 BMD values (total hip joint, femoral neck, greater trochanter, and femoral shaft) for an analyzed hip joint region. In this example, a ResNet algorithm, RegNetY160, is employed in model training.

A primary dataset and a secondary dataset are constructed before training the BMD generation model, wherein the primary dataset comprises labeled learning data and the secondary dataset comprises unlabeled learning data. To construct the primary dataset, clinical data of 3,169 pelvic X-ray images with corresponding DXA measurement from health facilities are transformed from DICOM files into high-resolution 16-bit PNG files. The images with abnormal bones such as artificial joints or fractures are excluded. The image brightness and contrast are standardized via a histogram normalization method. For each X-ray image, the corresponding DXA report with BMD sub-values of 4 regions (total hip joint, femoral neck, greater trochanter and femoral shaft) are matched to the X-ray image. Only the matches where the time interval between the X-ray radiograph and DXA measurement less than 6 months are included as training data. The DXA measurement contain BMD sub-values of total hip, femoral neck, greater trochanter and femoral shaft for each X-ray training image. Besides BMD sub-values, in each X-ray image the ground truth values of CTI and FNW are labeled by experts or suitable AI models. After construction, each set of primary learning data in the primary dataset comprises one original X-ray image and six ground truth values (total hip BMD, femoral neck BMD, greater trochanter BMD, femoral shaft BMD, CTI and FNW). In one embodiment, the ROI location model described above is applied to extract the total hip region of the original X-ray image, and the extracted ROI (instead of the original X-ray image) is used as the input image in the primary dataset. In yet another embodiment, both the original X-ray image and the extracted ROI are used as input images.

For constructing the secondary dataset, clinical data containing 3,215 pairs of X-ray images without BMD ground truth are collected from multiple health facilities, and 16-bit image pixel array are directly extracted from DICOM files. Each pair of X-ray images is a set of secondary learning data, which comprises two corresponding images of the same subject inferred to have similar BMD values. According to Berger et al. (CMAJ. 2008 Jun. 17;178(13):1660-8), BMD changes for a person is normally under 0.01 g/cm² per year. Considering that the variation of repeated DXA measurements by the same operator is around 2% (which is about 0.02g/cm²), two X-ray images of the same subject taken within 6 months can be reasonably considered as “similar” because the measurable difference is way below the variation between repeated measurements. Thus, in the secondary dataset each set of included secondary learning data comprises two X-ray images of the same person taken within 6 months. Similar to the primary dataset, in one embodiment the ROI location model is applied to extract the total hip region of the original X-ray images, and the extracted ROIs are used as the input images for each pair of X-ray images. In yet another embodiment, both the original X-ray images and the extracted ROIs are used as input images.

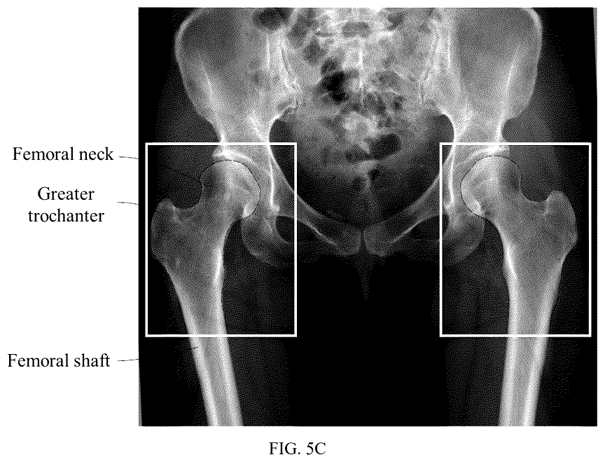

For model training, various approaches may be used to feed the data into the model. In one embodiment as shown in FIG. 6, a set of primary learning data randomly selected from the primary dataset and a set of secondary learning data randomly selected from the secondary dataset are combined and used to calculate a total loss. After selection, the learning data from the primary dataset further undergo image augmentation and ground truth augmentation to enhance the generalization ability of the model. The data augmentation method will be described in detail below. The random selection and augmentation may be performed on-the-fly during model training, or it may be created and cached in the memory beforehand to enhance loading speed during model training. In one modified embodiment, the secondary learning data from the secondary dataset also undergo image augmentation before training.

To train the prediction model to generate one or more BMD values, a CTI value and a FNW value, a total loss function comprises BMD accuracy term, CTI accuracy term, FNW accuracy term and BMD precision term is applied to calculate a total loss. The training goal is trying to reduce the calculated total loss as much as possible by adjusting the parameters in the BMD generation model. In one embodiment, the BMD comprises 4 BMD values (BMD of total hip, femoral neck, greater trochanter, and femoral shaft), and so the total loss function calculates the BMD accuracy and precision for all of the 4 BMD values.

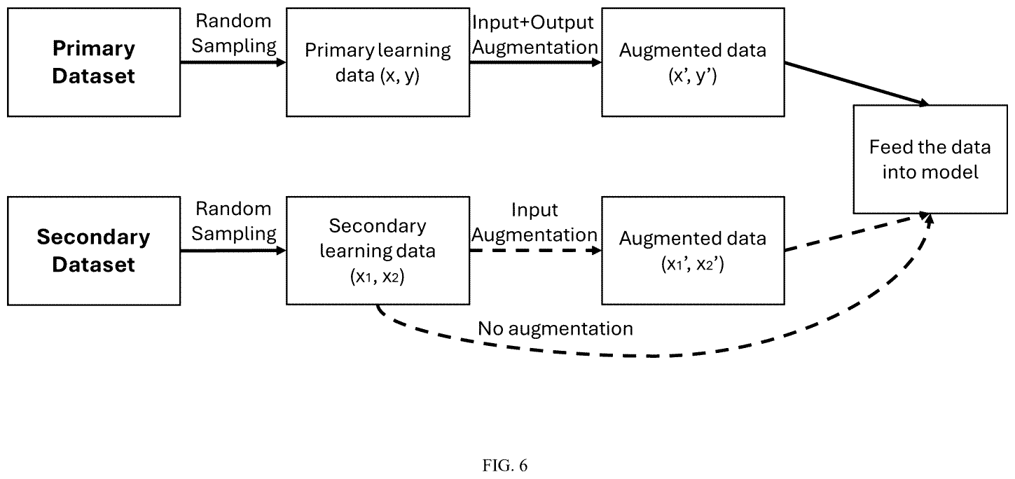

FIG. 7 shows an example to calculate a total loss. A selected primary learning data comprises an X-ray image P₁ with its BMD values of total hip Bₕ₁, femoral neck BMD B_{fn1}, greater trochanter BMD B_{gt1}, femoral shaft BMD B_{fs1}, CTI value C₁ and FNW value F₁. A selected secondary learning data comprises an X-ray image pair P₂ and P₃ without labeled ground truths. The selected learning data are fed to the model to generate corresponding outputs. For P₁, 4 predicted BMDs [symbol] , [symbol] , [symbol] , [symbol] , a predicted CTI [symbol] and a predicted FNW [symbol] are generated. For P₂ 4 predicted BMDs [symbol] , [symbol] , [symbol] , [symbol] are generated, and for P₃ 4 predicted BMDs [symbol] , [symbol] , [symbol] , [symbol] are generated. The total loss comprises an accuracy term calculated from primary learning data, and a precision term calculated from secondary learning data. In this example, the accuracy term calculates the differences between the predicted values and the ground truth, which has a primary loss to calculate BMD (a main feature) differences and a tertiary loss to calculate CTI and FNW (auxiliary features) differences. The precision term calculates BMD values between two sets of predicted values ( [symbol] , [symbol] , [symbol] , [symbol] ) and ( [symbol] , [symbol] , [symbol] , [symbol] ). In FIG. 7, square error such as mean square error is used to calculate the loss of the predicted results. However, other loss functions such as mean absolute error or mean absolute percentage error may also be used. Besides, although the weights of each component in each loss, and the weight of primary loss, secondary loss and tertiary loss are all set to one here, those weights may also be adjusted based on actual needs, or may be adjusted by hyperparameter optimization.

The model may then be trained with the primary and secondary datasets. In one example, in each training input a primary learning data from the primary dataset and a secondary learning data from the secondary dataset are randomly selected, and the primary learning data further undergoes image augmentation and ground truth augmentation. As described above, in one embodiment an ROI location model extracts ROIs of the X-ray images in the learning data, and for each learning data both the original image and the extracted ROI are used as inputs to train the model. During training, the batch size for each iteration is set between 4 and 32. The total training iterations is between 10 to 500, and stops when loss does not further decrease.

### 3. CTI Calculation Model

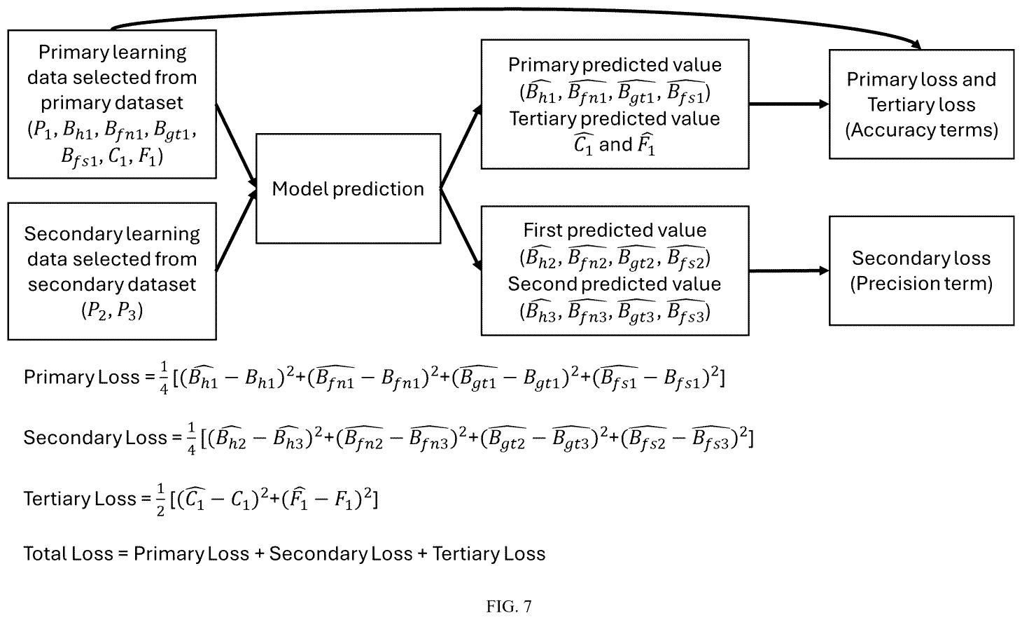

It is discovered that the cortical thickness of femur has positive correlation with BMD values of femoral neck, femoral shaft, greater trochanter, and total hip. For calculating the ground truth CTI value of an X-ray image, a CTI calculation model is described in US Patent Publication No. US2023/0029674A1, the contents of which are incorporated herein by reference. In brief, this model is used to find the characteristic points corresponding to the outer and inner edges of the cortical bone, as shown in the landmark of A, B, C, and D in FIG. 8. The training method for the CTI calculation model is as below:
(1) Preparing 153 hip joint X-ray images with characteristic points (i.e. points A, B, C, and D in FIG. 8) labeled by radiologists as training ground truth.
(2) Training High-Resolution Net (HRNet) algorithm to recognize the characteristic points.
(3) The trained AI model, which is a feature point detection model, can then be used to find the characteristic points in an input X-ray image.

After above training, the CTI value can thus be easily calculated by the equation: CTI=(AB−CD)/AB in percentage.

The CTI calculation model is only used to provide the CTI ground truth values for loss calculation during training of BMD generation model (instead of generating CTI values as inputs for BMD generation model). This is because the BMD generation model is trained to generate CTI values as outputs, not taking the values as inputs. This design forces the BMD generation model to focus on the correlation between CTI values and BMD values during training instead of passively receive the CTI values.

### 4. Data Augmentation

As described above, the learning data from the primary dataset further undergo image augmentation and ground truth augmentation to enhance the generalization ability of the BMD generation model. In image augmentation, the input image is slightly modified by operations including cropping, shifting, zooming in, zooming out, and adjusting brightness and/or contrast. With the random choices of the applied modifications, an input image may derive multiple modified images.

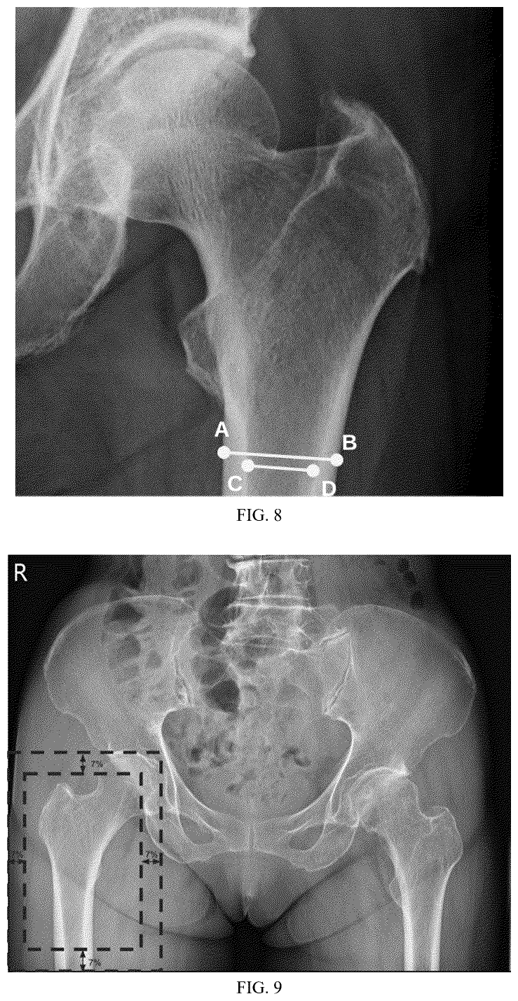

In one example, image augmentation comprises data augmentation on the original image and on the identified hip joint ROI. For data augmentation of an original X-ray image, up to 25% of the input X-ray image is randomly cropped with the premise of keeping the ROI uncropped, which may prevent the model from over-fitting to the image shooting and cropping characteristics of a specific medical institution. For data augmentation of the ROI, since different medical institutions or photography styles may slightly alter the identified ROI box, random displacement of 0-7% for the identified ROI is performed, which may alleviate problems of adaptation and generalization caused by ROI identification errors. FIG. 9 shows an example of performing random displacement to ROI. In this example, the ROI region is enlarged from the center by 7% for all 4 sides. The enlarged ROI is then randomly cropped. The ROI after cropping may have the same size with the originally identified ROI to simulate a pure displacement. Alternatively, the ROI after cropping may be smaller or larger than the originally identified ROI to simulate extra variations in ROI. Besides image cropping, random scaling and rotation may also be applied to simulate changes in photographing conditions.

For ground truth augmentation, the ground truth BMD values (total hip, femoral neck, greater trochanter, and femoral shaft BMD) are slightly modified within a small deviation. Similar to image augmentation, a BMD value in the training ground truth may derive multiple modified BMD values.

As described above, a small variable may be added to the original BMD value. In one example, the introduced small variable is a value randomly selected between ±0.01 g/cm². Alternatively, if the original BMD has a value yₙ, the introduced small variable may be a value randomly selected between ±0.01yₙ. A more complex probability density function may also be applied, too. In one example, ground truth augmentation is performed by introducing appropriate normally distributed variables to the original BMD values. Specifically, the introduced variables are selected based on a truncated normal distribution with population mean of 0 and truncates at ±0.01 g/cm². The variance or the standard deviation of the normal distribution may be changed to alter the distribution of added variables. In one embodiment, the standard deviation of the applied normal distribution is set as 1 g/cm². In another embodiment, the standard deviation of the applied normal distribution is set as 0.01 g/cm², so that the variables are more concentrated at the center region. The variations are applied to consider the measurement errors that may occur in DXA photography because of positioning, operator proficiency, and/or instrument calibration. This step aims to simulate the measurement variation in the real world and avoid overfitting the model to unobvious systematic errors that may exist in the training data, thereby improving the model's generalization ability.

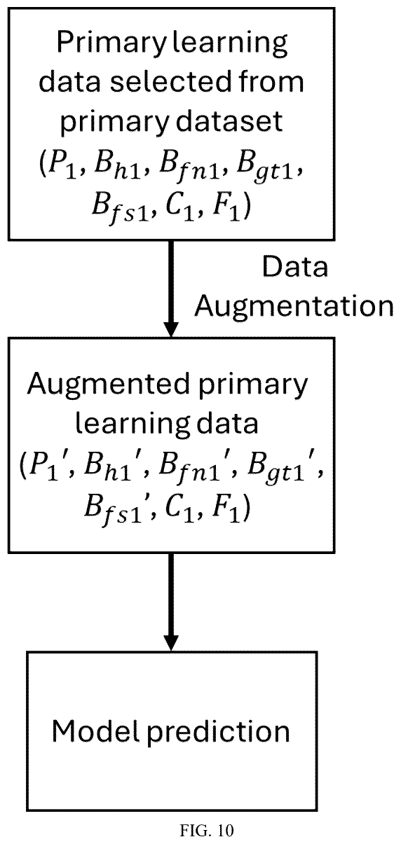

Lastly, the methods of image augmentation and ground truth augmentation are combined to generate learning data with both augmentations. Each randomly selected primary learning data comprises an input image and a set of ground truth values. The input image undergoes ROI recognition to generate an ROI image. Then the input image and the hip joint ROI undergo image augmentation as described above to generate a randomly modified input and a randomly modified ROI. The ground truth BMD values also undergo ground truth augmentation as described above to generate randomly modified BMD values (whereas the CTI and FNW values are original). Then, the modified input image, modified ROI, and the ground truth values with modified BMD are used as training materials in selected primary learning data, as shown in FIG. 10. Although the augmented data are artificial, it provides good representativeness to the real-world data obtained by DXA measurements.

### 5. Model Performance

To evaluate the performance of trained models, models with different training conditions are compared. The full model is a prediction model trained with precision term loss, image augmentation and ground truth augmentation which generates 4 BMD, 1 CTI and 1 FNW outputs. The contribution of adding a precision term (second loss term) to the loss function, applying data augmentation to the original input X-ray image (global image augmentation), applying data augmentation to the ROI image (local image augmentation), and applying ground truth augmentation to BMD ground truth (ground truth augmentation) are individually analyzed by removing each of the operations from the full model one at a time.

The testing data comprises X-ray images taken from 588 individuals. Among the 588 individuals, 420 took 2 X-ray images taken within short period of time, 77 took 3 X-ray images, 46 took 4 X-ray images, 31 took 5 X-ray images, and 14 took 6 or more X-ray images. The method described by Glüer et al. (Glüer C C, Blake G, Lu Y, Blunt B A, Jergas M, Genant H K. Osteoporos Int. 1995;5(4):262-70) in section is applied to calculate precision error. The result is as shown in Table 1.

TABLE 1
The comparison of different models by calculating the coefficient
of variation (CV) of predicted values for testing data

| Type of Trained Model | CV (%) |
|---|---|
| Full model | 2.78 |
| Remove precision term | 3.69 |
| Remove global (original) image augmentation | 3.42 |
| Remove local (ROI) image augmentation | 3.20 |
| Remove ground truth augmentation | 2.98 |

The model with all operations has a CV of 2.78%. Removing the precision term during training increases the CV from 2.78% to 3.69%. Omitting the data augmentation to original X-ray image in first dataset increases the CV to 3.42%. Omitting the data augmentation to ROI image in first dataset increases the CV to 3.20%. And omitting the output augmentation to BMD ground truth values increases the CV to 2.98%. It can be seen that each of the operations improves the performance of the model. However, adding the precision loss term during training contributes the most. This is in line with our assumption that using an unlabeled image pair forces the model to generate more consistent results for similar inputs.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded the widest scope consistent with the principles and novel features disclosed herein. It is contemplated that additional embodiments are within the spirit and true scope of the disclosed subject matter. Thus, it is intended that the present invention covers modifications and variations that come within the scope of the appended claims and their equivalents.

What is claimed is:

1. A method of training a prediction model to generate one or more main predicted values of a main feature of an input image, comprising training the prediction model with a primary dataset and a secondary dataset by adjusting multiple parameters in the prediction model to lower a total loss of the prediction model; wherein:
the primary dataset comprises multiple primary learning data, each of which comprises a labeled training image labeled with one or more main ground truth values of the main feature;
the secondary dataset comprises multiple secondary learning data, each of which comprises an unlabeled training image pair containing a first unlabeled training image and a second unlabeled training image having similarity in the main feature;
the total loss comprises a primary loss and a secondary loss;
the primary loss is calculated based on the difference between the one or more main ground truth values and one or more primary predicted values of the labeled training image, the one or more primary predicted value are one or more values of the main feature generated by the prediction model; and
the secondary loss is calculated based on the difference between one or more first predicted values of the first unlabeled training image and one or more second predicted values of the second unlabeled training image, the one or more first predicted values and the one or more second predicted values are one or more values of the main feature generated by the prediction model.

2. The method of claim 1, further comprising training the prediction model to generate one or more auxiliary predicted values of one or more auxiliary features of the input image by adjusting the multiple parameters in the prediction model to lower the total loss of the prediction model, wherein:
the one or more auxiliary features are correlated with the main feature;
the labeled training image of each of the multiple primary learning data is further labeled with one or more auxiliary ground truth values of the one or more auxiliary features;
the total loss further comprises a tertiary loss; and
the tertiary loss is calculated based on the difference between the one or more auxiliary ground truth values and one or more tertiary predicted values of the labeled training image, the one or more tertiary predicted values are one or more values of the one or more auxiliary features generated by the prediction model.

3. The method of claim 1, wherein the labeled training image is modified by image augmentation before generating the one or more primary predicted values by the prediction model.

4. The method of claim 1, wherein the one or more main ground truth values are modified by ground truth augmentation before calculating the primary loss.

5. The method of claim 1, wherein the primary loss and the secondary loss are calculated by squared loss functions.

6. The method of claim 1, wherein in each of the multiple secondary learning data the first unlabeled training image and the second unlabeled training image are images of the same subject taken within a predetermined time interval to have similarity in the main feature.

7. The method of claim 6, wherein the predetermined time interval is 3 months.

8. The method of claim 1, wherein each of the labeled training image, the first unlabeled training image and the second unlabeled training image is an ROI (region of interest) extracted image extracted from an original training image via ROI extraction.

9. The method of claim 1, wherein each of the labeled training image, the first unlabeled training image and the second unlabeled training image is a training image set comprising:
an original training image; and
an ROI (region of interest) extracted image extracted from the original training image via ROI extraction.

10. The method of claim 1, wherein the main feature is bone density of a subject, and the one or more main predicted value are one or more bone mineral density (BMD) values.

11. The method of claim 10, wherein the one or more main predicted values comprise bone mineral density (BMD) values of total hip, femoral neck, greater trochanter, and femoral shaft.

12. The method of claim 10, wherein the labeled training image in each of the primary learning data, and the first unlabeled training image and the second unlabeled training image in each of the secondary learning data are X-ray images.

13. The method of claim 12, wherein the first unlabeled training image and the second unlabeled training image are two X-ray images of the same subject taken sequentially within 3 months.

14. The method of claim 10, further comprising training the prediction model to generate one or more auxiliary predicted values of one or more auxiliary features of the input image by adjusting the multiple parameters in the prediction model to lower the total loss of the prediction model, wherein:
the one or more auxiliary features are correlated with the bone density of a subject;
the labeled training image of each of the multiple primary learning data is further labeled with one or more auxiliary ground truth values of the one or more auxiliary features;
the total loss further comprises a tertiary loss; and
the tertiary loss is calculated based on the difference between the one or more auxiliary ground truth values and one or more tertiary predicted values of the labeled training image, the one or more tertiary predicted values are one or more values of the one or more auxiliary features generated by the prediction model.

15. The method of claim 14, wherein the one or more auxiliary features comprise cortical thickness of the subject, and the one or more auxiliary predicted values comprise a cortical thickness index (CTI) value of the subject.

16. The method of claim 14, wherein the one or more auxiliary features comprise femoral neck width of the subject, and the one or more auxiliary predicted values comprise a femoral neck width (FNW) value of the subject.

17. The method of claim 12, wherein the labeled training image is a training image set comprising:
an original training image; and
an ROI extracted image which is an identified ROI region of a hip joint extracted from the original training image.

18. The method of claim 17, wherein the original training image and the ROI extracted image are modified by image augmentation before generating the one or more primary predicted values by the prediction model.

19. The method of claim 18, wherein said image augmentation is performed by cropping 0-25% of the original training image without cropping the identified ROI region, and wherein said image augmentation is performed by shifting the identified ROI region by 0-7% in a specific direction.

20. The method of claim 12, wherein the one or more main ground truth values are modified by introducing small variables randomly selected between −0.01 g/cm² and 0.01 g/cm².
